(19) United States
(12) Patent Application Publication
(10) Pub. No.: US 2003/0004703 A1
(43) Pub. Date: Jan. 2, 2003

(54) Method and system for localizing a markup language document

(76) Inventors: Arvind Prabhakar, Mountain View, CA (US); Lawrence White, Redwood City, CA (US); Kenneth Ebbs, Los Altos, CA (US)

Correspondence Address: Wagner Murabito & Hao LLP, Two North Market Street Third /Floor, San Jose, CA, 95113, US

(21) Appl. No.: 09/895,751

(22) Filed: Jun. 28, 2001

(51) Int. Cl. G06F 17/20

(52) U.S. Cl. 704/8

(57) ABSTRACT

Briefly, in accordance with one embodiment of the invention, a computer-implemented method for localizing a markup language document includes: identifying at least one token within a document and identifying a localizable string within the token. Creating a first file including a translation of the localizable string and a second file including the non-localizable data from the document. The first file and second file are then merged.

Briefly, in accordance with another embodiment of the invention, an article includes: a computer-readable medium including program instructions executable to: identify at least one token within the document and identify a localizable string within the token. Create a first file including a translation of at least one localizable string and a second file including non-localizable data from the document. The first file and second file are then merged.

Briefly, in accordance with still another embodiment of the invention, a first computer system including a processor and a memory storing program instructions. The processor is operable to execute the program instructions to: identify at least one token within the document and identify a localizable string within the token. Create a first file including a translation of at least one localizable string and a second file including non-localizable data from the document. The first file and second file are then merged.

### TECHNICAL FIELD

The present invention relates generally to data translation and more particularly to automating and customizing localization of markup language documents.

### BACKGROUND

When the development of electronic networks were mainly in the United States, there was little need for cultural-specific software components and translations. However, with the growth in the use of electronic networks, such as the Internet, the number of people attempting to distribute non-English content has grown substantially. As a result, the ability to provide localized content has become an important source of competitive advantage for companies competing in the global market place. In fact, any delays in providing a compatible version can potentially reduce market share in a certain country. It is therefore of critical importance to localize software quickly and in the most economical and efficient manner.

Localization is the process of developing cultural-specific software components and translations that can be accessed by internationalized software at run time. For example, localization may involve the translation of embedded text into a target language as well as adapting software text and code to accommodate the customs and conventions of a new locale.

Several software localization methods are known in the prior art. Some of these methods include several drawbacks that may be addressed by the present invention. For example, in some of these prior methods, localization is limited to translation of basic computer programs where all resource information (e.g., localizable strings) is separately stored in files, such as a resource dynamic link library (DLL), an executable binary file (.exe), or a plain ASCII text file. The executable object code, on the other hand, is located in at least one different and completely separate DLL. During the localization effort these prior methods, therefore, only require change in an identifiable resource file. Because markup language documents do not have a similar type of structure leading to rigid localization guidelines, the localization effort becomes more difficult.

Specifically, in markup language documents such as Hypertext Markup Language (HTML), Extensible Markup Language (XML), and Java Server Pages™ (JSP), for example, a single definition of what is considered localizable is completely non-existent or, alternatively, extremely vague. Even assuming rules exist for one type of markup language document (e.g., HTML) such rules may not apply to other types of markup language documents (e.g., JSP or XML documents). Therefore, these prior localization methods, if used to localize markup language documents, would provide extremely detrimental results, if any at all, as well as be subject to significant translation errors resulting in loss of quality, time, and capital. Furthermore, these prior methods are extremely error prone, time consuming, redundant, and require exhaustive repetitiveness.

### SUMMARY

Accordingly, a method and system for automating and customizing the localization of a markup language document while providing cost-savings, accuracy, flexibility, and efficiency is desired.

Briefly, in accordance with one embodiment of the invention, a computer-implemented method for localizing a markup language document includes: identifying at least one token within a document and identifying a localizable string within the token. Creating a first file including a translation of the localizable string and a second file including the non-localizable data from the document. The first file and second file are then merged.

Briefly, in accordance with another embodiment of the invention, an article includes: a computer-readable medium including program instructions executable to: identify at least one token within the document and identify a localizable string within the token. Create a first file including a translation of at least one localizable string and a second file including non-localizable data from the document. The first file and second file are then merged.

Briefly, in accordance with still another embodiment of the invention, a first computer system including a processor and a memory storing program instructions. The processor is operable to execute the program instructions to: identify at least one token within the document and identify a localizable string within the token. Create a first file including a translation of at least one localizable string and a second file including non-localizable data from the document. The first file and second file are then merged.

### BRIEF DESCRIPTION OF THE DRAWINGS

The subject matter regarded as the invention is particularly pointed out and distinctly claimed in the concluding portion of the specification. The invention, however, both as to organization and method of operation, may best be understood by reference to the following detailed description, when read with the accompanying drawings, in which:

FIG. 1 is a flow chart of a system for localizing a computer program according to one embodiment of the present invention.

FIG. 2 is a flow chart including a sub-system for localizing a computer program according to one embodiment of the present invention.

FIG. 3 is a flow chart including another sub-system for localizing a computer program according to one embodiment of the present invention.

FIG. 4 is a flow chart including still another sub-system for localizing a computer program according to one embodiment of the present invention.

FIG. 5 is a flow chart including an implementation of a system for localizing a computer program in a computer-readable medium according to one embodiment of the present invention.

FIG. 6 is a block diagram of a computer system in which the present invention may be embodied.

### DETAILED DESCRIPTION

In the following detailed description, numerous specific details are set forth in order to provide a thorough understanding of the invention. However, it will be understood by those skilled in the relevant art that the present invention may be practiced without these specific details. In other instances, well-known methods, procedures, and components have not been described in detail so as not to obscure the present invention.

As previously described, localization is the process of adapting a product or computer program for a specific region or country, which is often referred to as a locale. Typically, localization is used for translating user interfaces and the supporting documentation of a product or computer program. A successfully localized product or computer program is one the appears to have been developed within the local culture. As a result, when developing products or computer programs designed for multiple locales, it is beneficial for developers and software localization teams to have a tool, such as the present invention, to aid in the localization effort.

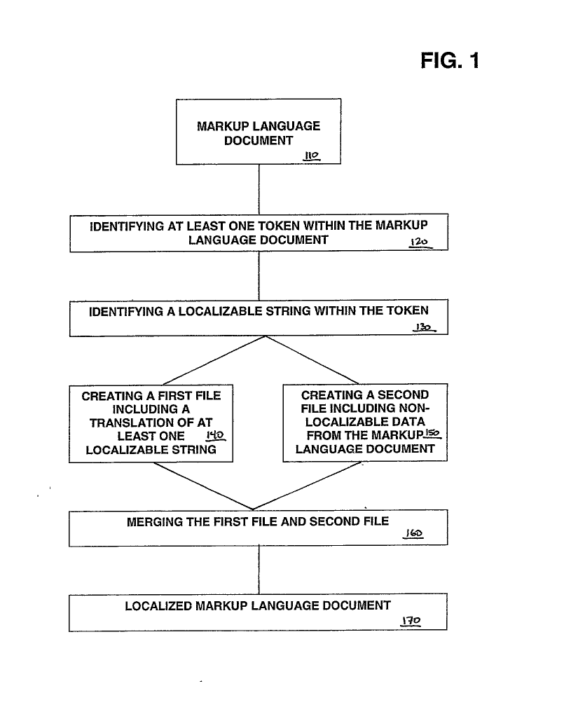

FIG. 1 illustrates a flow chart diagram of the localization effort involved in the translation from one locale to another locale in accordance with one embodiment of the present invention. As shown in block 110, a markup language document generally includes a sequence of characters or other symbols that are inserted at certain places in a text or word processing file to indicate how the file should look when it is printed or displayed or to describe the document's logical structure. Markup language documents can include documents such as Hypertext Markup Language (HTML), Extensible Markup Language (XML), and Java Server Pages™ (JSP), for example. In FIG. 1, block 110 illustrates a markup language document, that is localized by identifying at least one token within the markup language document, as shown in block 120. A token is at least one string made up of one or more characters that follow a recognizable pattern, such as a set of strings that have been parsed from a larger set of strings given a set of predefined classification rules. Using these pre-defined classification rules, token factories, in a parent-child framework for example, identify tokens.

For example, the pre-defined classification rules used by token factories to identify tokens can be based upon whether a string of characters, upon screening, is bounded or unbounded. A bounded string of characters refers to a string of characters that begin with an outermost delimiter “<” and end with a corresponding outermost delimiter “>”. As a result, any string of characters within delimiters that are within the outermost matching delimiters (e.g., nested delimiters) are not bounded. For example, in the string “<abc=def ghi =<jkl>mno =pqr>” the string “<jkl>” does not qualify as bounded. Additionally, any nested delimiter must have a corresponding delimiter unless such delimiter is exempted (e.g., escaped) under a markup language construct rule (e.g., when the delimiter is within a comment). Examples of bounded strings include the following:

<html>

<meta http-equiv=“Content-Type” content=“text/html; charset=iso-8859-1”>

<meta name=“GENERATOR” content=“Mozilla/4.75 [en] (Windows NT 5.0; U) [Netscape]”>

<TD ALIGN=RIGHT>

<x:HTML map=“com.iplanet.ecommerce.vortex.oms.display.JspTagMapping”>

<%@ include file=“../include/OMSInclusionHeader.jsp”%>

<%

String[ ] data=bean.getStringValues(STATUS_DATA);

String[ ] values=bean.getStringValues(STATUS_VALUES);

String[ ] selected=bean.getStringValues(STATUS_SELECTED);

for (int i=0; i<data.length; i++)

%≧

<%=bean.getStringValue(FILTER_BY DESC)%>

<A HREF=“<%=ordLinks[i]%>”>

<IMG SRC=“<%=”/@ IMM_DOCROOT@/images/buttons/”+FILE_PREFIX +“left.gif”%>“BORDER=“0”>

Alternatively, an unbounded string of characters refers to a string of characters that are not bounded. Specifically, in one embodiment, an unbounded string of characters refers to a string of characters that (a) begins either (i) at the first character of a markup language or (ii) immediately preceding a delimiter meeting the definition of a corresponding outermost delimiter “>” of a bounded string of characters, and (b) ends either (i) at the last character of a markup language document or (ii) immediately preceding a delimiter meeting the definition of an outermost delimiter “<” of a bounded string of characters. Additionally, there are instances when certain delimiters are exempted (e.g., escaped) under a markup language construct rule. For example, in the string—abcd “<efgh>” ijkl —, since the delimiters are within double quotes, these delimiters are exempted and the entire string is thus unbounded. Examples of unbounded strings include the following:

Profile Name:&nbsp;

Welcome “<%=getUserName( )%>” to our homepage

OMS: View Orders

Created Date:&nbsp;

&copy;Sun Microsystems, Inc. 2001

Syntax:&It;%=bean.getDateValue(DF_CREEATION_DATE,SIMPLE_DATE_FORMAT_YEAR)% &gt;

Syntax:&It;A HREF=“javascript:BSSCPopup(‘Buyer.htm’);

As stated previously, pre-defined classification rules, such as those above, are used by token factories to identify tokens. For example, a token consisting of various numeric strings may have been initially screened by a parent token factory using certain general pre-defined classification rules and further screened by a child token factory using more specific pre-defined classification rules, and so on. In this instance, the exemplary token may include strings, such as:

“233 2343 2343”

“8.000034340e-19”

“234 ½”

To identify this exemplary token, a parent token factory utilized pre-defined classification rules, such as those described above with respect to unbounded strings, resulting in the identification of an “unbounded” token. This “unbounded” token is passed to a child token factory for either assignment, as described below, or further classification. In this particular instance, the “unbounded” token can be further classified by the child token factory, according to more specific pre-defined classification rules, as an “unbounded numeric” token. The specific pre-defined classification rules used to do so, for example, could have included the rules: (a) collect strings that consist only of numbers and/or white spaces and/or (b) collect stings that contain the characters “.”, “e”, “+”, “+”, and/or “−”.

After identification of at least one token is complete, the strings that require actual translation within the token are distinguished. This is accomplished by identifying at least one localizable string within the token, as shown in block 130, based on pre-defined localization rules. Pre-defined localization rules can, for example, be managed and implemented by a token handler that specializes in parsing a given type of string (e.g., a bounded HTML string) to identify the exact portions of the string that may require translation. In one embodiment, a token handler is flexible in nature and allows for any rules and semantics to be added at any time by enhancing or modifying a token handler or with additional token handlers. The process of using the token handler begins, using one or more token factories to identify a particular token, as described above. In this example, the following strings comprise several exemplary “bounded” tokens:

<a href=“xyz”>

<a href=“zdf” onMouseOver=“javascript:status(‘show this message’)”>

<a name=“someone” value=“somevalue” href=“dfdf”>

To identify these “bounded” tokens, a parent token factory utilizes a classification rule such as that described above regarding bounded strings. From this point, the “bounded” tokens are sent to a child token factory which determines whether such tokens should be passed to an all-purpose token handler or be further classified and passed to a specific token handler(s). In this particular instance, these “bounded” tokens can be further classified by the child token factory, according to more specific pre-defined classification rules, as a “a-type bounded” tokens. In order to now identify a localizable string(s) within any of the “a-type bounded” tokens, a token handler specific to these and similar types of tokens will parse each “a-type bounded” token, using predefined localization rules, to identify the exact portions of the strings, if any, that require translation. The pre-defined localization rules can include, for example, a rule or rules such as: (a) do not localize this type of token; (b) always localize the attribute name; (c) always localize everything that appears in double quotes; (d) always localize everything that appears in double quotes other than the strings that begin with “javascript:”; (e) always localize everything that appears in double quotes other than the strings that being with “javascript:” that should be parsed separately to identify any alert, confirm, or status messages which should be localized; and/or (f) if the identified string is made up of spaces, numbers, or special characters, do not localize. This flexible construct allows rules for identifying localizable strings that can range from extremely simple to extremely complex. Furthermore, modules such as hooks can further be provided to modify or extend the behavior of these token handlers. A hook is a place and usually an interface provided in packaged code that allows a programmer to insert customized programming.

In one embodiment, it should also be understood that in the case a localizable string is not identified within a particular token or markup language document, the process immediately continues to the next token or markup language document, if any, to complete the localization effort for a set or group of tokens or markup language documents.

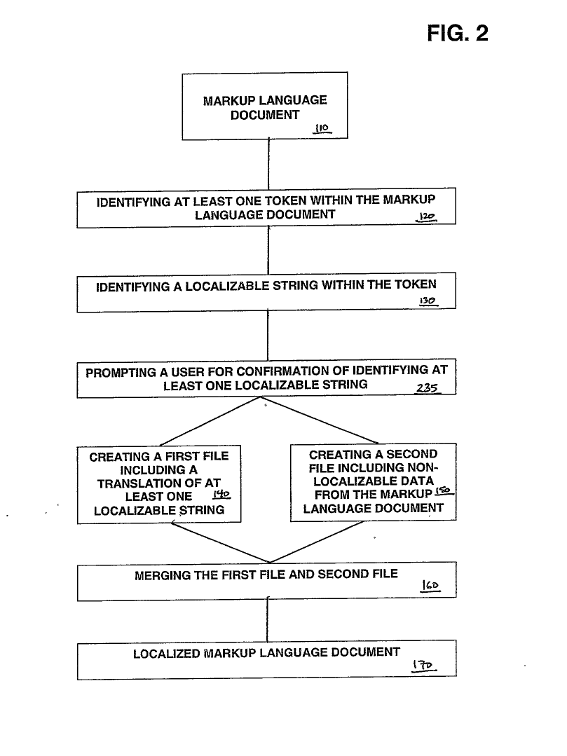

In another embodiment control over, or interaction with, the identification of localizable strings within a token may be desired by a user. Interaction by a user is desired in cases of parsing complex tokens, such as multi-line JSP scriplet tokens, because it is extremely difficult and inefficient to create pre-defined localization rules that apply in every instance and situation. In other words, there may be ambiguous situations where the applicability of a localization rule is indeterminate or unclear to the token handler. As shown in block 235 of FIG. 2, to remedy this ambiguous situation, the token handler will prompt the user to verify or confirm whether a particular string, or portions of a string, should be identified for localization. If confirmed by the user, the string is extracted from the markup language document for translation. If not confirmed by the user, the string is not extracted from the markup language document. In the event interaction is not desired (e.g., when localizing a large volume of documents at one time), the token handler identifies localizable strings based solely on the pre-defined localizable rules without prompting the user for confirmation or instruction.

Referring back to FIG. 1, once a localizable string within a token has been identified, the next steps include creating a first file (e.g., property file) including a translation of at least one localizable string, as shown in block 140, as well as creating a second file (e.g., template file) including non-localizable data from the markup language document, as shown in block 150. The first file, therefore, includes a list of translated localizable strings exacted from the markup language document in a readable format and indexed in an order corresponding to the place holder strings in the second file. The second file, therefore, includes of all the original markup language, or other similar constructs, with the exception of the identified localizable strings being replaced by indexed place holder strings.

Upon creation of the appropriate files, as shown in FIG. 1, merging the first file and second file, as illustrated in block 160, generates a localized markup language document, as shown in-block 170, for the intended locale. Merging occurs when each string from the first file is combined with each corresponding indexed place holder string or “slot” in the second file left by the previous extraction of each localizable string.

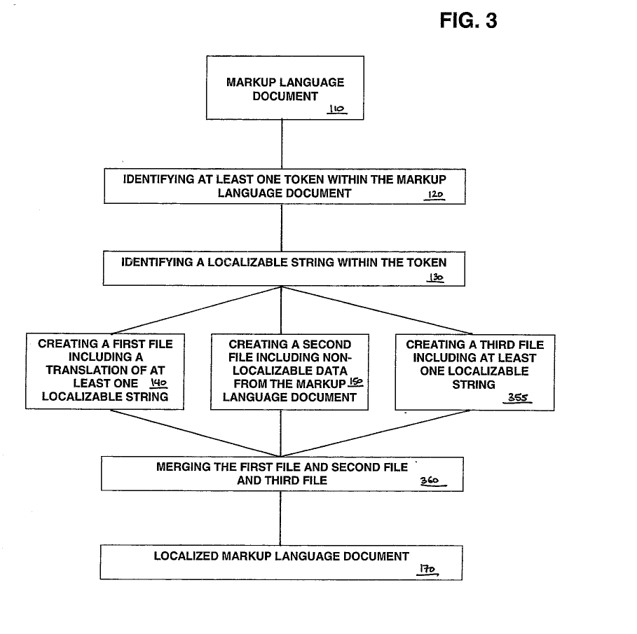

In an alternative embodiment, as shown in FIG. 3, a third file (e.g., property file) including at least one original (non-translated) localizable string from a token within the markup language document is created, as shown in block 355, based on identification by the token handler, as described above. The third file, therefore, includes a list of localizable strings extracted from the markup language document in a readable format and indexed in an order that corresponds to the place holder strings in the second file. This third file can further aid the localization effort. For example, the third file can aid localization by saving the original localizable string should no translation be available in the dictionary module. This will be explained in more detail below. Although the dictionary module contains translations between two languages in a language neutral manner, as described below, there may be instances where a particular translation is not available in the dictionary module because it was not initially anticipated, known, or intended to be included.

As stated previously, the third file includes an original localizable string from the markup language document prior to translation. In cases where there is no available translation of a particular string for combination with the corresponding slot in the second file, the slot in the second file is combined with the corresponding original localizable string from the third file. As a result, merging of the first file and second file and third file, as shown in block 360 occurs. This may be desired, for example, when a user must localize a voluminous markup language document. In this circumstance, interaction, as explained above, may not be desired due to the potentially large quantity of confirmations, and thus time, that may be required. This non-interaction results in a token handler making localization decisions without input from a user and may result in the unintended localization of a string. For example, a particular localization rule may guide a token handler to identify a string, such as “<z d:rr” to be localized from English to Japanese. Since such a string is made up of characters intended for execution by a computer, no localization of this string may be necessary or desired. Accordingly, in the dictionary module, there may not be an available translation for combination with the corresponding slot in the second file. The slot in the second file, therefore, is combined with the corresponding original localizable string from the third file. In this manner, the original string “<z d:rr” is preserved and the code integrity within the markup language document is sustained.

This same effect can also be achieved with interaction by the user. Specifically, it can be achieved when, in ambiguous token handler situations, a user is prompted for confirmation of the identification of a localizable string and the user decides not to confirm that particular localization.

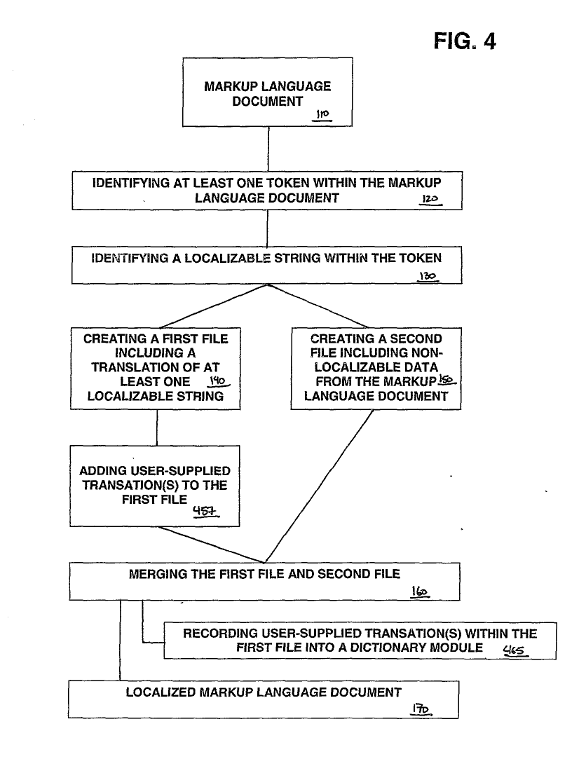

As stated previously, translations are based on the dictionary module. The dictionary module contains pre-existing dictionary translations (e.g., “hello” in English is equivalent to “bonjur” in French and vice versa) and is preferably language neutral and XML based. Language neutrality allows for dynamic, two-way translations rather than only one-way translations. For example, language neutrality allows for translations from English to Japanese as well as from Japanese to English. The dictionary module further allows for the recordation of manual translations done by a user when localizing a document from one language to another. Specifically, as shown in FIG. 4, if a particular translation is in question or unavailable within the dictionary module, a user may manually view the first file to validate a translation(s) provided by the dictionary module and/or edit or add appropriate user-supplied translation(s), as shown in block 457. As a result, translations may contain a dictionary translation and/or user-supplied translation. Furthermore, during merging of the first file and second file the user-supplied translation is recorded, in a persistent store for example, within the dictionary module for use in future localization efforts, as shown in block 465. Upon recordation, the user-supplied translation becomes a pre-existing dictionary translation for use in later runs. Accordingly, the dictionary module increases accuracy as well as the productivity of localization efforts.

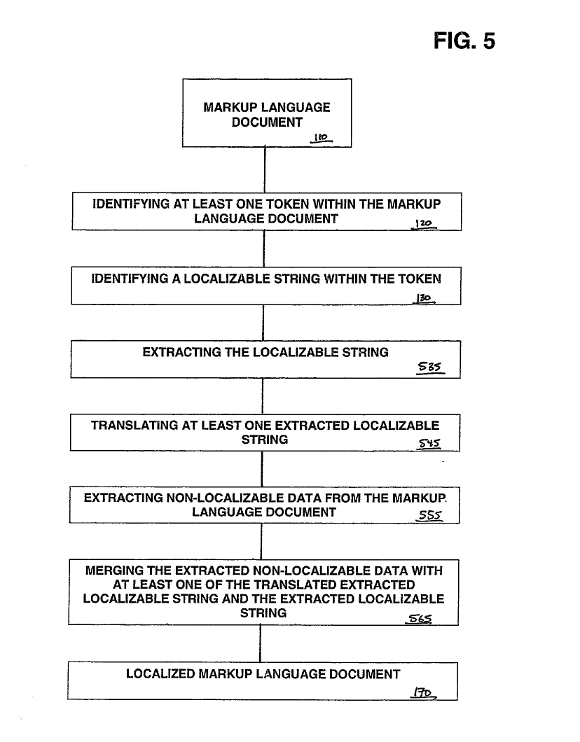

It is further to be understood that in one embodiment, the process flow and features described above, could be accomplished entirely in a computer-readable medium without the use or need for separate files. Accordingly, FIG. 5 illustrates a flow chart diagram of the localization effort performed entirely in memory (e.g., a computer-readable medium) and involving localization from one locale to another locale. Specifically, blocks 110-130 represent the same process flow as previously described. However, block 535 illustrates extracting the-localizable string from the markup language document and block 555 illustrates extracting the non-localizable data from the markup language document. Rather than creating separate files, as described previously, the extracted strings are stored in a computer-readable medium. In between block 535 and block 555 is block 545 which shows the translation of at least one extracted localizable string from block 535. This translated extracted localizable string is likewise stored in a computer-readable medium and can be viewed, edited, modified, and added to directly from the computer-readable medium. The next block in the process flow is block 565 where merging of the extracted non-localizable data with at least one of the translated extracted localizable string and the extracted localizable string takes place. Merging can also occur in a computer-readable medium, the result and output of which is a localized markup language document, as shown in block 170. Here, either the translated extracted localizable string and/or the extracted localizable string is merged with the extracted non-localizable data based on interaction and translation factors, as described previously. All previous embodiments as described above can likewise be applied to this embodiment.

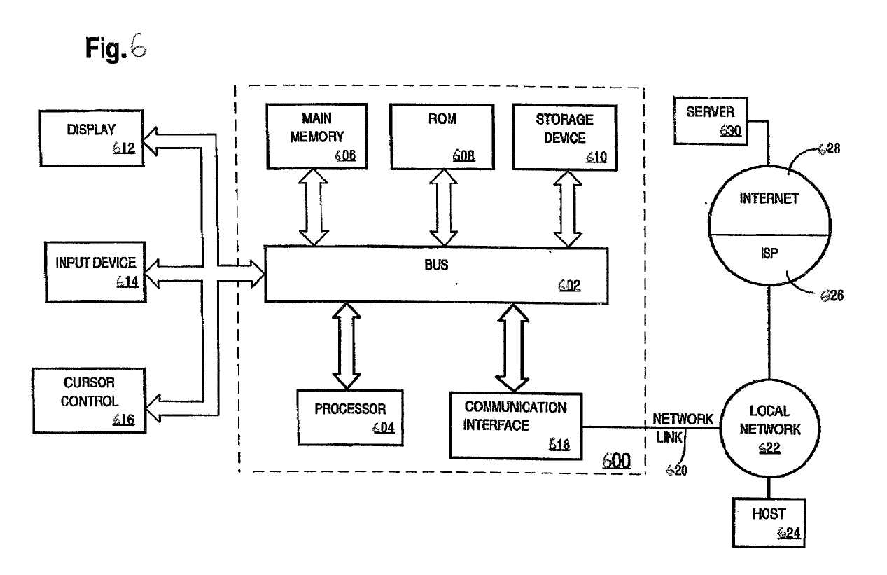

FIG. 6 shows a hardware block diagram of a computer system 600 in which an embodiment of the invention may be implemented. Computer system 600 includes a bus 602 or other communication mechanism for communicating information, and a processor 604 coupled with bus 602 for processing information. Computer system 600 also includes a main memory 606, such as random access memory (RAM) or other dynamic storage device, coupled to bus 602 for storing information and instructions by processor 604. Main memory 606 may also be further used to store temporary variables or other intermediate information during execution of instructions by processor 604. Computer system 600 further includes a read only memory (ROM) 608 or other static storage device coupled to bus 602 for storing static information and instructions for processor 602. A storage device 610, such as a magnetic or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 412, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

According to one embodiment, the functionality of the present invention is provided by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission data includes coaxial cables, copper wire and fiber optics, including the wires that comprise bus 602. Transmission media can also take the form of acoustic or electromagnetic waves, such as those generated during radio-wave, infra-red, and optical data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 604 carries the data to main memory 606, for which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution. In this manner, computer system 600 may obtain application code in the form of a carrier wave.

At this point, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the appended claims.

1. A computer-implemented method for localizing a markup language document, comprising:
identifying at least one token within said document;
identifying a localizable string within said token;
creating a first file including a translation of at least one said localizable string;
creating a second file including non-localizable data from said document; and
merging said first file and said second file.

2. The method of claim 1 further comprising, prompting a user for confirmation of said identifying at least one localizable string

3. The method of claim 1 further comprising, creating a third file including at least one said localizable string.

4. The method of claim 3 wherein said merging includes merging said third file.

5. The method of claim 1 further comprising, editing said first file to provide a user-supplied translation.

6. The method of claim 5 wherein said merging further includes recording said user-supplied translation within said first file into a dictionary module.

7. The method of claim 1 wherein said translation includes at least one of a dictionary translation and a user-supplied translation.

8. The method of claim 1 wherein said identifying at least one token includes screening a string of characters within said document to determine whether said string of characters is at least one of bounded and unbounded.

9. The method of claim 1 wherein said localizable string includes at least one of data and executable code.

10. A computer-readable medium comprising program instructions executable to:
identify at least one token within said document;
identify a localizable string within said token;
create a first file including a translation of at least one said localizable string;
create a second file including non-localizable data from said document; and
merge said first file and said second file.

11. The computer-readable medium of claim 10, further comprising program instructions executable to prompt a user for confirmation of said identify at least one localizable string.

12. The computer-readable medium of claim 10, further comprising program instructions executable to create a third file including at least one said localizable string.

13. The computer-readable medium of claim 12, wherein said merge includes merging said third file.

14. The computer-readable medium of claim 10, further comprising program instructions executable to edit said first file to provide a user-supplied translation.

15. The computer-readable medium of claim 14, where in said merging further includes recording said user-supplied translation within said first file into a dictionary module.

16. The computer-readable medium of claim 10, wherein said translation includes at least one of a dictionary translation and a user-supplied translation.

17. The computer-readable medium of claim 10, wherein said identifying at least one token includes screening a string of characters within said document to determine whether said string of characters is at least one of bounded and unbounded.

18. The computer-readable medium of claim 10, wherein said localizable string includes at least one of data and executable code.

19. A first computer system comprising:
a processor;
a memory storing program instructions;
wherein the processor is operable to execute the program instructions to:
identify at least one token within said document;
identify a localizable string within said token;
create a first file including a translation of at least one said localizable string;
create a second file including non-localizable data from said document; and
merge said first file with said second file.

20. The system of claim 19, further comprising program instructions executable to prompt a user for confirmation of said identify at least one localizable string.

21. The system of claim 19, further comprising program instructions executable to create a third file including at least one said localizable string.

22. The system of claim 21, wherein said merge includes merging said third file.

23. The system of claim 19 further comprising program instructions executable to edit said first file to provide a user-supplied translation.

24. The system of claim 23, wherein said merging further includes recording said user-supplied translation within said first file into a dictionary module.

25. The system of claim 19, wherein said translation includes at least one of a dictionary translation and a user-supplied translation.

26. The method of claim 19 wherein said identifying at least one token includes screening a string of characters within said document to determine whether said string of characters is at least one of bounded and unbounded.

27. The system of claim 19, wherein said localizable string includes at least one of data and executable code.

28. A computer-implemented method for localizing a markup language document, comprising:
identifying at least one token within said document;
identifying a localizable string within said token;
extracting said localizable string from said document;
translating at least one said extracted localizable string;
extracting non-localizable data from said document; and
merging said extracted non-localizable data with at least one of said translated extracted localizable string and said extracted localizable string.

29. The method of claim 28 further comprising, prompting a user for confirmation of said identifying a localizable string.

30. The method of claim 28 further comprising, editing said translated extracted localizable string to provide a user-supplied translation.

31. The method of claim 30 wherein said merging further includes recording said user-supplied translation within a dictionary module.

32. The method of claim 28 wherein said translating utilizes at least one of a dictionary translation and a user-supplied translation.

33. The method of claim 28 wherein said identifying at least one token includes screening a string of characters within said document to determine whether said string of characters is at least one of bounded and unbounded.

34. The method of claim 28 wherein said localizable string includes at least one of data and executable code.

35. A computer-readable medium comprising program instructions executable to:
identify at least one token within said document;
identify a localizable string within said token;
extract said localizable string from said document;
translate at least one said extracted localizable string;
extract non-localizable data from said document; and
merge said extracted non-localizable data with at least one of said translated extracted localizable string and said extracted localizable string.

36. The computer-readable medium of claim 35 further comprising program instructions executable to prompt a user for confirmation of said identify a localizable string.

37. The computer-readable medium of claim 35 further comprising program instructions executable to edit said translated extracted localizable string to provide a user-supplied translation.

38. The computer-readable medium of claim 37 wherein said merge further includes recording said user-supplied translation within a dictionary module.

39. The computer-readable medium of claim 35 wherein said translate utilizes at least one of a dictionary translation and a user-supplied translation.

40. The computer-readable medium of claim 35 wherein said identifying at least one token includes screening a string of characters within said document to determine whether said string of characters is at least one of bounded and unbounded.

41. The computer-readable medium of claim 35 wherein said localizable string includes at least one of data and executable code.

42. A first computer system comprising:
a processor;
a memory storing program instructions;
wherein the processor is operable to execute the program instructions to:
identify at least one token within said document;
identify a localizable string within said token;
extract said localizable string from said document;
translate at least one said extracted localizable string;
extract non-localizable data from said document; and
merge said extracted non-localizable data with at least one of said translated extracted localizable string and said extracted localizable string.

43. The system of claim 42 further comprising program instructions executable to prompt a user for confirmation of said identify a localizable string.

44. The system of claim 42 further comprising program instructions executable to edit said translated extracted localizable string to provide a user-supplied translation.

45. The system of claim 44 wherein said merge further includes recording said user-supplied translation within a dictionary module.

46. The system of claim 42 wherein said translate utilizes at least one of a dictionary translation and a user-supplied translation.

47. The method of claim 42 wherein said identifying at least one token includes screening a string of characters within said document to determine whether said string of characters is at least one of bounded and unbounded.

48. The system of claim 42 wherein said localizable string includes at least one of data and executable code.
